(19) United States
(12) Patent Application Publication
(10) Pub. No.: US 2015/0154178 A1
(43) Pub. Date: Jun. 4, 2015

(54) COARSE SEMANTIC DATA SET ENHANCEMENT FOR A REASONING TASK

(71) Applicant: Empire Technology Development LLC, Wilmington, DE (US)

(72) Inventor: Jun Fang, Shaanxi (CN)

(21) Appl. No.: 14/412,412

(22) PCT Filed: Apr. 19, 2013
(86) PCT No.: PCT/CN2013/074448

§ 371 Date: Dec. 31, 2014

(51) Int. Cl. G06F 17/27

(52) U.S. Cl. CPC G06F 17/2785

(57) ABSTRACT

Technologies are generally described for enhancing semantic data to be used by a reasoning task. In some examples, a method and a system for removing inconsistent data from, and adding enhancement data to, a coarse data set are described. The method may include receiving, by a data enhancement module, a first set of semantic data associated with the reasoning task. The method may include generating, by the data enhancement module, a second set of semantic data by removing inconsistent data from the first set of semantic data, wherein the inconsistent data is identified from the first set of semantic data by a justification determination process. The method may further include generating, by the data enhancement module, a third set of semantic data by adding enhancement data to the second set of semantic data, wherein the enhancement data is obtained based on the second set of semantic data by an abduction determination process.

### BACKGROUND

In semantic ubiquitous computing, a semantic data set may be coarse because 1) the semantic data set may be formed by a fusion of data from different heterogeneous data sources, or 2) the semantic data set may be collected from sources that contain errors or natural noises. The coarse data set may include inconsistent data, which contains error information that should be removed, and incomplete data, which lacks some important information that should be provided. Coarse data set may significantly decrease the quality of semantic services.

### SUMMARY

According to some embodiments, a method for enhancing data to be used by a reasoning task may include receiving, by a data enhancement module, a first set of semantic data associated with the reasoning task. The method may include generating, by the data enhancement module, a second set of semantic data by removing inconsistent data from the first set of semantic data. The inconsistent data may be identified from the first set of semantic data by a justification determination process. The method may further include generating, by the data enhancement module, a third set of semantic data by adding enhancement data to the second set of semantic data. The enhancement data may be obtained based on the second set of semantic data by an abduction determination process.

According to other embodiments, a method for enhancing data to be used by a reasoning task may include receiving, by a data enhancement module, a first set of data associated with the reasoning task. The method may include identifying, by the data enhancement module via a justification determination process, inconsistent data from the first set of data, and generating, by the data enhancement module, a second set of data by removing the inconsistent data from the first set of data. The method may further include generating, by the data enhancement module via an abduction determination process, enhancement data based on the second set of data, and generating, by the data enhancement module, a third set of data by adding the enhancement data to the second set of data. The third set of data may contain a self-consistent and self-complete ontology for the reasoning task.

According to other embodiments, a system for performing a reasoning task, the system may include a data enhancement module and a reasoning engine. The data enhancement module may be configured to receive a first set of semantic data, and generate a second set of semantic data by removing inconsistent data from a first set of semantic data. The inconsistent data may be identified from the first set of semantic data by a justification determination process. The data enhancement module may further be configured to generate a third set of semantic data by adding enhancement data to the second set of semantic data. The enhancement data may be obtained based on the second set of semantic data by an abduction determination process. The reasoning engine may be coupled with the data enhancement module, and may be configured to generate a set of reasoning results based on the third set of semantic data.

According to other embodiments, a non-transitory machine-readable medium may have a set of instructions which, when executed by a processor, cause the processor to perform a method for enhancing data to be used by a reasoning task. The method may include receiving, by a data enhancement module, a first set of semantic data associated with the reasoning task. The method may include generating, by the data enhancement module, a second set of semantic data by removing inconsistent data from the first set of semantic data. The inconsistent data may be identified from the first set of semantic data by a justification determination process. The method may further include generating, by the data enhancement module, a third set of semantic data by adding enhancement data to the second set of semantic data. The enhancement data may be obtained based on the second set of semantic data by an abduction determination process.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are therefore not to be considered limiting of its scope, the disclosure will be described with additional specificity and detail through use of the accompanying drawings.

In the drawings:

FIG. 1 is a block diagram of an illustrative reasoning system for enhancing a coarse semantic data set;

FIG. 2 is a block diagram illustrating certain details of the reasoning system of FIG. 1;

FIG. 3 is a flowchart of an illustrative method for enhancing data to be used by a reasoning task;

FIG. 4 is a block diagram of an illustrative computer program product implementing a method for enhancing data to be used by a reasoning task; and

FIG. 5 is a block diagram of an illustrative computing device which may be used to enhance data to be used by a reasoning task, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is generally drawn, inter alia, to technologies including methods, apparatus, systems, devices, and computer program products related to the enhancing of a coarse semantic data set for a reasoning task. In some embodiments, a data enhancement module first receives a first set of semantic data associated with the reasoning task. The first set of semantic data may contain inconsistent and incomplete data. The data enhancement module may generate a second set of semantic data by removing inconsistent data from the first set of semantic data, and generate a third set of semantic data by adding enhancement data to the second set of semantic data. Thus, the third set of semantic data may contain a self-consistent and a self-complete ontology. Further, for multiple possible solutions to fix the inconsistent and incomplete data, the data enhancement module may select the solutions that are less related with the reasoning task as the ones to repair the inconsistency; and select solutions which have greater relatedness with the reasoning task as the ones to fix the incompleteness.

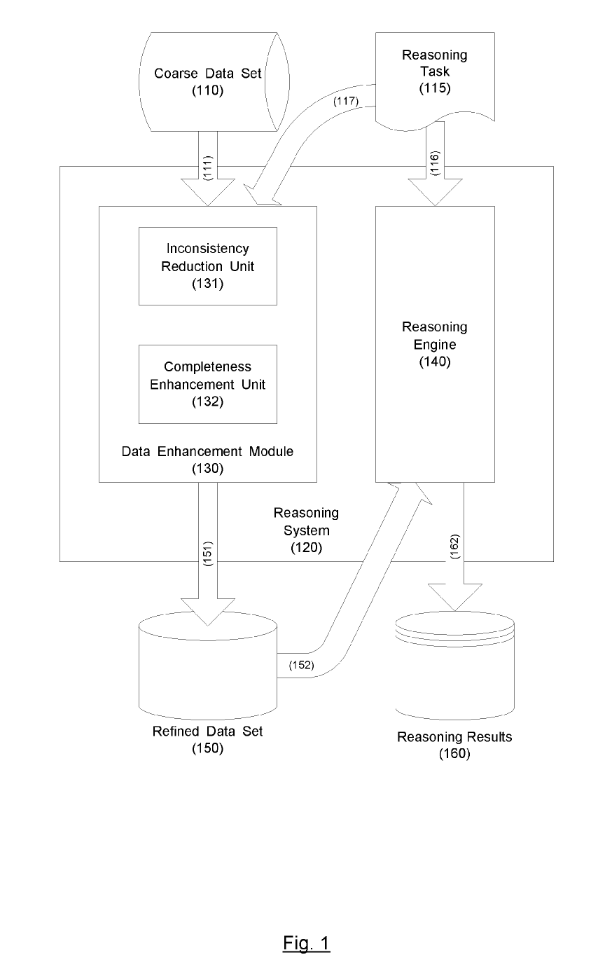

FIG. 1 is a block diagram of an illustrative reasoning system 120 for enhancing a coarse semantic data set, arranged in accordance with at least some embodiments described herein. As depicted, the reasoning system 120 may be configured to process a coarse data set 110 in order to generate a refined data set 150. The reasoning system 120 may further be configured to process a reasoning task 115 based on the refined data set 150, and generate a set of reasoning results 160. The reasoning system 120 may be configured with, among other components, a data enhancement module 130 and a reasoning engine 140. Specifically, the data enhancement module 130 may be configured to enhance the coarse data set 110 in order to generate the refined data set 150. The reasoning engine 140 may be configured to receive as inputs the refined data set 150 and generate the reasoning results 160 for the reasoning task 115.

In some embodiments, the coarse data set 110 may contain a set of semantic data obtained from a database or a data source (e.g., Internet data retrieved via a search engine), and may include inconsistent data and/or incomplete data. A set of “semantic data” may refer to meaningful information which can be extracted and interpreted without human intervention. The semantic data may contain an “ontology” having categories and domains of knowledge and information. A consistent and complete set of semantic data (or a consistent and complete ontology) may be modeled or analyzed for their inner structures, hidden relationships, and/or implied meanings. However, the inconsistent data in the coarse data set 110 may be either erroneous or contradictory information; and the incomplete data in the coarse data set 110 may lack one or more pieces of information. In order for the reasoning engine 140 to generate meaningful reasoning results 160, the data enhancement module 130 may first generate the refined data set 150 by repairing the inconsistency and fixing the incompleteness in the coarse data set 110. Afterward, the reasoning engine 140 may perform classical reasoning operations based on the refined data set 150.

In some embodiments, the data enhancement module 130 may be configured with, among other components, an inconsistency reduction unit 131 and a completeness enhancement unit 132. The inconsistency reduction unit 131 may take the coarse data set 110 as an input (111), remove some inconsistent data from the coarse data set 110, and generate a set of consistent data. The completeness enhancement unit 132 may then add some enhancement data to the set of consistent data in order to generate the refined data set 150. The details about the inconsistency reduction unit 131 and the completeness enhancement unit 132 are further described below.

In some embodiments, the reasoning system 120 may provide the refined data set 150 as an output 151. The outputted refined data set 150 may be used for further enhancement and analysis by other systems not shown in FIG. 1. Further, the reasoning engine 140 may take the refined data set 150 as an input (152), and perform knowledge-based operations based on the reasoning task 115 as an input (116), in order to generate (162) the reasoning results 160. By way of example, the reasoning tasking 115 may request the reasoning engine 140 to perform a satisfiability (e.g., consistency) checking, an instance checking, and/or a subsumption checking on the refined data set 150. The reasoning engine 140 may be configured to perform deductive reasoning, inductive reasoning, and/or abductive reasoning to fulfill the reasoning task 115, utilizing formal and/or informal logical operations based on the refined data set 150. The generated reasoning results 160 may include conclusions such as whether two statements are consistent with each other, whether one statement may be considered a subsumption of the other, and/or whether a statement may be true for a specific subject.

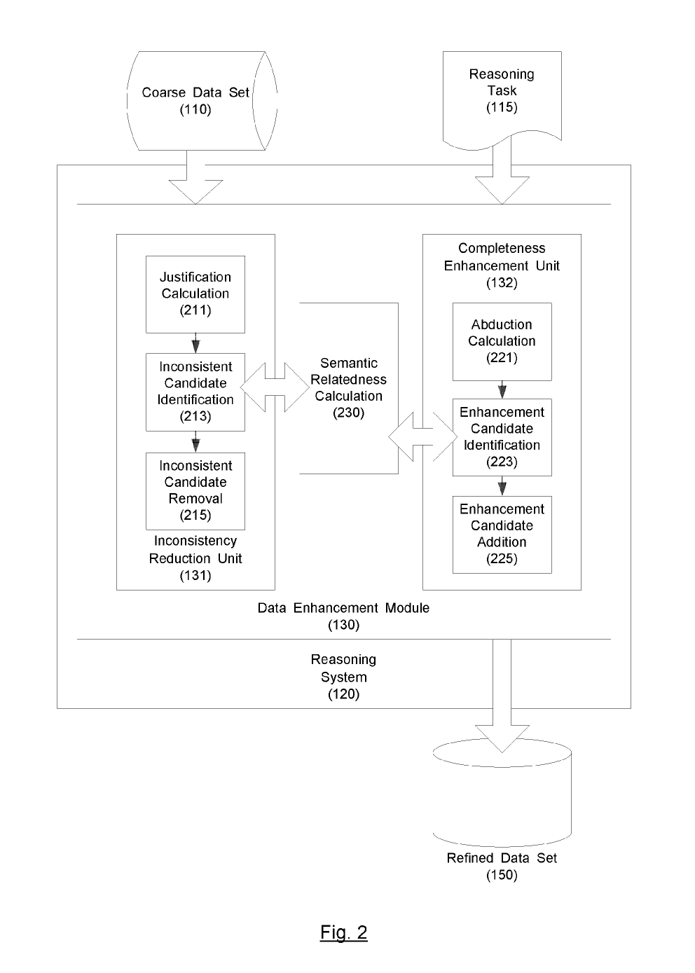

FIG. 2 is a block diagram illustrating certain details of the reasoning system 120 of FIG. 1, arranged in accordance with at least some embodiments described herein. In FIG. 2, the coarse data set 110, the reasoning task 115, the reasoning system 120, the data enhancement module 130, the inconsistency reduction unit 131, the completeness enhancement unit 132, and the refined data set 150 correspond to their respective counterparts in FIG. 1. The inconsistency reduction unit 131 may be configured with, among other logic components, components for performing justification calculation 211, inconsistent candidate identification 213, and inconsistent candidate removal 215. The completeness enhancement unit 132 may be configured with, among other logic components, components for performing abduction calculation 221, enhancement candidate identification 223, and enhancement candidate addition 225. Further, a module for semantic relatedness calculation 230 may be utilized by the inconsistency reduction unit 131 and the completeness enhancement unit 132 accordingly.

In some embodiments, the data enhancement module 130 may refine the coarse data set 110 by finding “justifications” using the justification calculation 211, identify “inconsistent candidates” based on the justifications using the inconsistent candidate identification 213, and remove the inconsistent candidates from the coarse data set 110 using the inconsistent candidate removal 215, in order to generate a “consistent data set.” The data enhancement module 130 may then generate “abductions” using the abduction calculation 221, identify “enhancement candidates” based on the abductions using the enhancement candidate identification 223, and add the enhancement candidates to the consistent data set using the enhancement candidate addition 225, before generating the refined data set 150. The data enhancement module 130 may perform the inconsistency reduction before the completeness enhancement because the abduction calculation 221 may require a consistent data set. Optionally, the data enhancement module 130 may utilize the semantic relatedness calculation 230 to filter the inconsistent candidates and/or the enhancement candidates.

In some embodiments, a semantic data set may be inconsistent when there are one or more justifications in the semantic data set. A “justification” may be an inconsistent set of data that, when removing any one piece of data from the set, will change into a consistent set of data. In order to repair the inconsistency in the coarse data set 110, the inconsistency reduction unit 131 may perform justification calculation 211 to locate one or more justifications in the coarse data set 110. In some embodiments, the inconsistency reduction unit 131 may perform justification calculation 211 to locate all justifications in the coarse data set 110.

The justification calculation 211 may be illustrated using the following description logic notations. A piece of semantic data may be denoted as an “axiom.” When dealing with inconsistency, the coarse data set 110 may be deemed as an inconsistent axiom set, or “an inconsistent ontology.” A justification may be defined as a minimal axiom set that explains one inconsistency in the inconsistent ontology. For example, a justification, which contains a first axiom “length>0” and another axiom “length<0”, may be inconsistent, as length cannot be larger than 0 and smaller than 0 at the same time. However, by removing any one of these two axioms in the justification's axiom set, the remaining axioms in the justification may become consistent. In another example, an inconsistent justification' axiom set may contain the following three axioms: a>b; b>c; and c>a. The justification may become consistent by removing any one of these three axioms from the justification's axiom set.

In one description logic notation, justification may be defined as the following:
given an inconsistent ontology O (O [symbol] ⊥), an axiom set O′ is a justification of O iff (if and only if) it satisfies the conditions:
   i) O′⊂O; ii) O′ [symbol] ⊥; iii) ∀O″ (O″⊂O′ [symbol] O″ [symbol] ⊥)
      The first condition indicates that the axiom set O′ contains less amount of axioms than, or the same amount of axioms as, the ontology O. The second condition states that the axiom set O′ is also inconsistent. The third condition describes that for any axiom subset O″ of the axiom set O′ (meaning the subset O″ contain less axioms than the set O′), the subset O″ is no longer inconsistent. Thus, the axiom set O′ may be deemed a justification for the ontology O.

In some embodiments, the justification calculation 211 may compute one or more justifications in the inconsistent ontology O using a “Hitting Set Tree (HST)” algorithm as shown in the following algorithm 1:

Algorithm 1
Algorithm 1. ComputeAllJustifications

Function-1: ComputeAllJustifications(O)

| | |
|---|---|
| 1: | S, curpath, allpaths ← |
| 2: | ComputeAllJustificationsHST(O, S, curpath, allpaths) |
| 3: | return S |

Function-1R: ComputeAllJustificationsHST(O, S, curpath, allpaths)

| | |
|---|---|
| 1: | for path ∈ allpaths do |

| | |
|---|---|
| 2: | if curpath ⊃ path then |

| | | |
|---|---|---|
| 3: | return | //Path termination without consistency check |

| | |
|---|---|
| 4: | if IsConsistent(O) then |

| | |
|---|---|
| 5: | allpaths ← allpath ∪ {curpath} |
| 6: | return |

| | |
|---|---|
| 7: | J ← |
| 8 | for s ∈ S do |

| | |
|---|---|
| 9: | if s ∩ path = then |

| | | |
|---|---|---|
| 10: | J ← s | //Justification reuse (saves recomputing a |

justification)

| | |
|---|---|
| 11: | if J = then |

| | |
|---|---|
| 12 | J ← ComputeSingleJustification(O) |

| | |
|---|---|
| 13: | S ← S ∪ {J} |
| 14 | for ax ∈ J do |

| | |
|---|---|
| 15: | curpath ← curpaths ∪ {ax} |
| 16: | ComputeAllJustificationsHST(O \ {ax}, S, curpath, allpaths) |

In algorithm 1, the function “ComputeAllJustifications” may take an ontology O as an input, and return a set S containing one or more justifications identified from the ontology O. The function ComputeAllJustifications may invoke a recursive function “ComputeAllJustificationsHST” in order to build a hitting set tree. The hitting set tree may have nodes labeled with justifications found in the ontology, and edges labeled with axioms from the ontology. In algorithm 1, the found justifications are stored in the variable S, and the edges are stored in the variable allpaths.

A function “ComputeSingleJustification” (line 12 in algorithm 1) may be invoked to identify a specific justification in the ontology. In lines 14-16, for each axiom ax in the justification J, the axiom ax is put onto the hitting set tree as an edge, and the ComputeAllJustificationHST function is called based on an ontology “O/{ax}” that has the axiom ax removed.

The function ComputeSingleJustification is shown in the following algorithm 2.

Algorithm 2
Algorithm 2. ComputeSingleJustification

| Function-2: ComputeSingleJustification(O) | |
|---|---|
| 1: | return ComputeSingleJustification(, O) |
| Function-2R: ComputeSingleJustification(S, F) | |
| 1: | if \|F\| = 1 then |

| | |
|---|---|
| 2: | return |

| | |
|---|---|
| 3: | S_{L}, S_{R}, ← split(F) |
| 4: | if IsInconsistent(S ∪ S_{L}) then |

| | |
|---|---|
| 5: | return ComputeSingleJustification(S, S_{L}) |

| | |
|---|---|
| 6: | if IsInconsistent(S ∪ S_{R}) then |

| | |
|---|---|
| 7: | return ComputeSingleJustification(S, S_{R}) |

| | |
|---|---|
| 8: | S′_{L} ← ComputeSingleJustification(S ∪ S_{R}, S_{L}) |
| 9: | S′_{R} ← ComputeSingleJustification(S ∪ S′_{L}, S_{R}) |
| 10: | return S′_{L} ∪ S′_{R} |

In algorithm 2, the function ComputeSingleJustification may take an ontology O as an input, and return an identified justification. In line 3 of the algorithm 2, the justification calculation 211 may partition the ontology into two halves SL and SR, in order to check whether one, the other, or both, of the two halves are inconsistent. In lines 4-7, if one of the SL and SR is inconsistent, the justification calculation 211 may perform recursive computation by calling or invoking the ComputeSingleJustification function on the inconsistent half. Otherwise, the SL may be inconsistent with respect to SR. In this case, the algorithm 2 may perform recursive computation in lines 8-9 by calling or invoking the ComputeSingleJustification function on SL, using the other half SR as a support set, and then on SR, using SL as a support set.

In some embodiments, after identifying the justifications, the inconsistency reduction unit 131 may perform inconsistent candidate identification 213 to identify inconsistent candidates from the justifications. The inconsistent candidate identification 213 may first generate a set of “relevance candidates”, which are candidates for repairing the inconsistency in the coarse data set 110, based on the justifications. By way of example, the set of relevance candidates may contain a set of tuples, and may be a Cartesian product of the identified justifications. In one description logics notation, the set of relevance candidates RC_Set may be shown as

RC_Set=j₁×j₂× . . . ×jₙ;

j₁, j₂, . . . jₙ are the identified justifications.
For example, assuming justification j₁ contains axioms {a, b}, and justification j₂ contains axioms {c, d, e}, then the set of relevance candidates RC_Set may be a Cartesian product of j₁ and j₂, and may contain a set of tuples {(a, c), (a, d), (a, e), (b, c), (b, d), (b, e)}.

In some embodiments, based on the reasoning task 115, the inconsistent candidate identification 213 may invoke the semantic relatedness calculation 230 to generate a corresponding “semantic relatedness score” for each relevance candidate rc selected from the set of relevance candidates RC_Set. Based on the generated semantic relatedness scores, the inconsistent candidate identification 213 may then select one or more “inconsistent candidates” from the set of relevance candidates RC_Set. A relevance candidate having a low semantic relatedness score may indicate that the relevance candidate has a low relatedness with the reasoning task 115. In one implementation, the one or more “inconsistent candidates” may be those of the relevance candidates that have corresponding semantic relatedness scores below a predetermined threshold. Alternatively, an inconsistent candidate may be one of the relevance candidates that has the lowest semantic relatedness score. Thus, this relatedness-based selection may remove those axioms that are less related with the reasoning task 115.

As a measurement of the relatedness between a specific relevance candidate rc and the reasoning task 115 (denoted “T” below), the semantic relatedness score may be calculated using two entity sets S1 and S2:
Relatedness (rc, T)=rel (S1, S2), where S1 and S2 may include concepts, roles, and individuals in the solution candidate rc and the reasoning task T, respectively.
   In other words, the semantic relatedness calculation 230 may populate S1 with concepts, roles, and individuals extracted from the solution candidate rc, populate S2 with concepts, roles, and individuals extracted from the reasoning task T, and perform its calculation based on the two entity sets S1 and S2. The details of the semantic relatedness calculation are further described below.

In some embodiments, the inconsistency reduction unit 131 may perform the inconsistent candidate removal 215 based on the one or more inconsistent candidates identified by the inconsistent candidate identification 213. Specifically, the inconsistent candidate removal 215 may remove one or more elements in the identified inconsistent candidates from the coarse data set 110, and generate a consistent data set corresponding to a consistent ontology. The data enhancement module 130 may then provide the consistent data set to the completeness enhancement unit 132 for use in fixing the data incompleteness.

In some embodiments, the completeness enhancement unit 132 may perform abduction calculation 221 to generate one or more abductions based on the consistent data set. An “abduction” is a form of logical inference in order to obtain hypothesis that can explain relevant evidence. Since the consistent data set may contain incomplete data that lacks certain vital information, a reasoning engine (not shown in FIG. 2) may not be able to generate expected reasoning results for the reasoning task 115 without having additional information. The abductions may be deemed explanations to the partial or incomplete semantic data, and may be used to generate possible solutions for fixing the incomplete data. In other words, finding or identifying enhancement candidates to fix the incompleteness may be conduct by a process of abduction calculation. The calculated abductions may have one or more axioms that, when used along with an incomplete ontology, can lead to reasoning results and/or explain observations that may not be explained by using the incomplete ontology alone.

In one description logic notion, the incomplete ontology O may contain at least one observant axiom “OA” that may not be explained under a reasoning task T. Thus, the abduction calculation 221 may be defined as the following:
given an abduction problem <O, OA>, O [symbol] OA and O∪OA [symbol] ⊥, an abduction is a process to find abduction solutions S which satisfies
   O∪S [symbol] OA and O∪S [symbol] ⊥
      In other words, given an ontology O and an observation OA, even though the ontology O and the observation OA are not inconsistent, the ontology O by itself cannot be used to explain the observation OA. Once an abduction solution S that is not inconsistent with the ontology O is found, the ontology O plus the abduction solution S may be sufficient in explaining the observation OA.

In some embodiments, the abduction calculation 221 may first utilize a tableau algorithm to process the consistent ontology (i.e., the consistent data set obtained from the inconsistency reduction unit 131) and construct a completion forest which has a set of trees with roots nodes that are arbitrarily interconnected, with nodes that are labeled with a set of concepts, and with edges that are labeled with a set of role names. The abduction calculation 221 may then construct a labeled and directed graph with each node being a root of a tree in the completion forest. Afterward, the abduction calculation 211 may apply expansion rules on the labeled and directed graph based on description logic concepts.

In some embodiments, the abduction calculation 211 may use the completion forest to find abduction solutions. Given a consistent data set as the completion forest and the observation in query axiom forms, the abduction solutions may be axioms which can close every branch of a completion tree in the completion forest. Furthermore, closing a specific branch may refer to having a concept and a negation of the same concept in the specific branch, and the concept and the negation of the same concept may result in a clash. Based on the above process, abduction calculation 211 may generate a set of “abduction candidates” AC_Set for fixing the incomplete data.

In some embodiments, the enhancement candidate identification 223 may invoke the semantic relatedness calculation 230 to generate a corresponding “semantic relatedness score” for each abduction candidate ac selected from the set of abduction candidates AC_Set and associated with a specific observation in the consistent data set. Based on the generated semantic relatedness scores, the enhancement candidate identification 223 may then select one or more enhancement candidates from the abduction candidates AC_Set. In one implementation, the one or more enhancement candidates may be selected for having corresponding semantic relatedness scores that are above a predetermined threshold. Alternatively, an enhancement candidate may be one of the abduction candidates that has the highest semantic relatedness score. Thus, this relatedness-based selection may in a way coincide with human intuition, since axioms that are more related to the observation are also more likely to complement the incomplete ontology.

The semantic relatedness score may be used as a measurement of the relatedness between a specific abduction candidate ac and an observation OA, and may be calculated using two entity sets S3 and S4:
Relatedness (rc, OA)=rel (S3, S4), where S3 and S4 may include concepts, roles, and individuals in the abduction candidate ac and the observation OA, respectively.
   In other words, the semantic relatedness calculation 230 may populate S3 with concepts, roles, and individuals extracted from the abduction candidate ac; populate S4 with concepts, roles, and individuals extracted from the observation OA; and perform its calculation based on the two entity sets S3 and S4. The details of semantic relatedness calculation are further described below.

In some embodiments, the completeness enhancement unit 132 may perform the enhancement candidate addition 225 based on the one or more enhancement candidates identified by the enhancement candidate identification 213. Specifically, the enhancement candidate addition 225 may add the identified enhancement candidates to the consistent data set, and generate a refined data set 150 corresponding to a consistent and complete ontology. A reasoning engine may then process the refined data set 150 to generate reasoning results, as described above.

In some embodiments, as mentioned above, the semantic relatedness calculation 230 may generate semantic relatedness scores for the inconsistent candidates and/or the enhancement candidates. The semantic relatedness calculation 230 may use a search-based approach to generate a semantic relatedness score based on two input entity sets. Specifically, the search-based approach may use search results obtained by inputting elements of the entity sets to a search engine (e.g., Google® search engine). Thus, the search-based approach is more precise and up-to-date, and may not be limited by language.

In some embodiments, the semantic relatedness calculation 230 may calculate the semantic relatedness score based on “web statistics” obtained from the search engine. Since words that appear in the same web page may have some semantic relatedness, for two words (e.g., two keywords) respectively selected from the two input entity sets, the higher the amount of web pages including these two words, the higher the semantic relatedness score may be. Thus, the semantic relatedness calculation 230 may utilize a search engine to perform three searches by using word₁, word₂, and “word₁+word₂” as search requests. Afterward, the semantic relatedness calculation 230 may track the number of web pages (or hits) returned from the search engine for each of these three searches, and calculate the semantic relatedness score based on the following formula:

$${rel}_{statistic} ( {word}_{1} , {word}_{2} ) = \frac{hits ( {word}_{1} + {word}_{2} )}{min ( hits ( {word}_{1} ) , hits ( {word}_{2} ) )}$$

Here, the hits(word₁+word₂) may refer to the number of web pages returned by search using word₁ AND word₂. The min(hits(word₁), hits(word₂)) may refer to the minimum number of hits from the two searches results, one by searching using word₁ and another by searching using word₂. The semantic relatedness score obtained from the above formula may be a value between 0 and 1, with 0 meaning no relationship between word₁ and word₂, and 1 meaning highest degree of relationship between word₁ and word₂.

Thus, any result web pages obtained from searching separately and jointly using word₁ and word₂ may be an indication that these two words are somehow associated with each other. In one embodiment, the minimum function, average function, or maximum function may be applied to the above formula to calculate the semantic relatedness score. The maximum function may not be suitable for situations when the first keyword yields a large number of hits, while the second keyword yields a much smaller number of hits. In this case, if the second keyword is highly associated with the first keyword, using the maximum function may yield a semantic relatedness score that is too low to reflect the strong correlation between the two keywords.

In some embodiments, the semantic relatedness calculation 230 may also calculate the semantic relatedness score based on “web contents” obtained from the search engine. Specifically, the semantic relatedness calculation 230 may separately input the two keywords into the search engine, and track the first n number of ranked web pages returned from the search engine. The semantic relatedness calculation 230 may use the contents of the two set of n-number web-pages to generated two context vectors that correspond to the two keywords. The context vectors may be highly reliable in representing the meaning of the searched keywords.

In some embodiments, the context vector (\vec{v}) may be generated based on the first n number of ranked web pages returned from a search engine using the search keyword w. The n number of web pages may be split into tokens, case-folded, and stemmed. Then, the variations such as case, suffix, and tenses may be removed from the tokens. Next, the context vector may be initialized as a zero vector. For each occurrence of the keyword (e.g., word₁) in the tokens, the context vector may be incremented by 1 for those dimensions of vector which correspond to the words present in a specified window win of context around the keyword. Here, the window win may be used to define the context of the keyword word₁ in the web pages. Afterward, the semantic relatedness calculation 230 may calculate the semantic relatedness score based on the following formula:

$${rel}_{content} ( {word}_{1} , {word}_{2} ) = \frac{{{v}^{->}}_{1} \cdot {{v}^{->}}_{2}}{\vert {{v}^{->}}_{1} \vert \vert {{v}^{->}}_{2} \vert}$$

Here, \vec{v}₁ and \vec{v}₂ may be the context vectors corresponding to word₁ and word₂, respectively.

In some embodiments, the semantic relatedness calculation 230 may further calculate the semantic relatedness score by combing the above “web statistics” and “web contents” approaches. In other words, the semantic relatedness score may be a value derived from the rel_{statistic} and rel_{content}. For example, the semantic relatedness score may be calculated based on the following formula:

rel_{combined}=α·rel_{content}+(1−α)·rel_{statistic}

Here, α controls the influence of the two parts. In other words, a may be assigned with a configurable value between 0 and 1, and can be used to adjust which of the two relatedness scores rel_{content} and rel_{statistic} should weigh in the final result rel_{combined}.

When calculating a semantic relatedness score based on two input entity sets U and V, the semantic relatedness calculation 230 may utilize the following formula:

$$rel ( U , V ) = \frac{{rel}_{search} ( {u}_{i} , {v}_{j} )}{\vert U \vert V \vert} , {u}_{i} ∈ U , {v}_{j} ∈ V$$

In other words, the semantic relatedness score for the two input entity sets may be the average score of all relatedness scores for all elements in these two input entity sets.

The above process may be further illustrated by the following example. In some embodiments, the data enhancement module 130 may receive a coarse data set 110, which may contain an economy ontology and a reasoning task 115 for making an investment plan. The economy ontology may be coarse because it contains inconsistent data, and it does not explain an observation that “the price of oil is increasing.” The data enhancement module 130 may process the coarse data set 110 using the justification calculation 211, which may identify the following two justifications J1 and J2 in the coarse data set 110:
J1={(a: the exchange rate of RMB against US dollar increases);
   (b: the exchange rate of US dollar against HK dollar increases);
   (c: the exchange rate of RMB against HK dollar decreases)}
J2={(e: the exchange rate of RMB against Euro decreases);
   (f: the exchange rate of Euro against US dollar decreases);
   (a: the exchange rate of RMB against US dollar increases)}
      As illustrated, the justifications J1 and J2 contain conflicting information, which may become consistent when removing any one of the elements from each of the justifications.

Next, the data enhancement module 130 may utilize the inconsistent candidate identification 213 to generate, based on the justifications J1 and J2, a set of relevance candidates RC_Set={(a), (a,e), (a,f), (b,e), (b,f), (b,a), (c,e), (c,f), (c,a)}. Note that the axiom a is present in both justifications J1 and J2. Therefore, there is a relevance candidate which only contain one element a. Afterward, the inconsistent candidate identification 213 may calculate a corresponding semantic relatedness score for each of the above 9 relevance candidates based on the reasoning task 115. Upon a determination that for instance, elements of the relevance candidate (b, e) are seldom being reported in news and has the lowest semantic relatedness score, the inconsistent candidate identification 213 may identify (b,e) as the inconsistent candidate. The data enhancement module may invoke the inconsistent candidate removal 215 to remove the two elements b and e from the coarse data set 110 in order to generate a consistent data set.

Furthermore, as the observation “price of oil is increasing” may not be explained by the economy ontology, the economy ontology may have incomplete data. The data enhancement module 130 may then provide the consistent data set to the abduction calculation 221, which identifies the following set of abduction candidates based on the observation:
AC_Set={(a: shortage of Oil); (b: Inflation); (c: Car number increases); (d: war in oil exporting region); . . . }
   Thus, the data enhancement module 130 may fix the incompleteness in the economy ontology by adding any one of the above abduction candidates to the economy ontology.

In some embodiments, the data enhancement module 130 may utilize the enhancement candidate identification 223 to calculate a corresponding semantic relatedness score for each of the above abduction candidates. The enhancement candidate identification 223 may then determine that abduction candidates a and c are frequently reported in recent news, and may have semantic relatedness scores that are above a predetermined threshold (e.g., 0.5). Thus, the enhancement candidate identification 223 may select the abduction candidates a and c as the enhancement candidates. The data enhancement module 130 may then instruct the enhancement candidate addition 225 to add the enhancement candidates a and c to the consistent data set, resulting a refined data set 150.

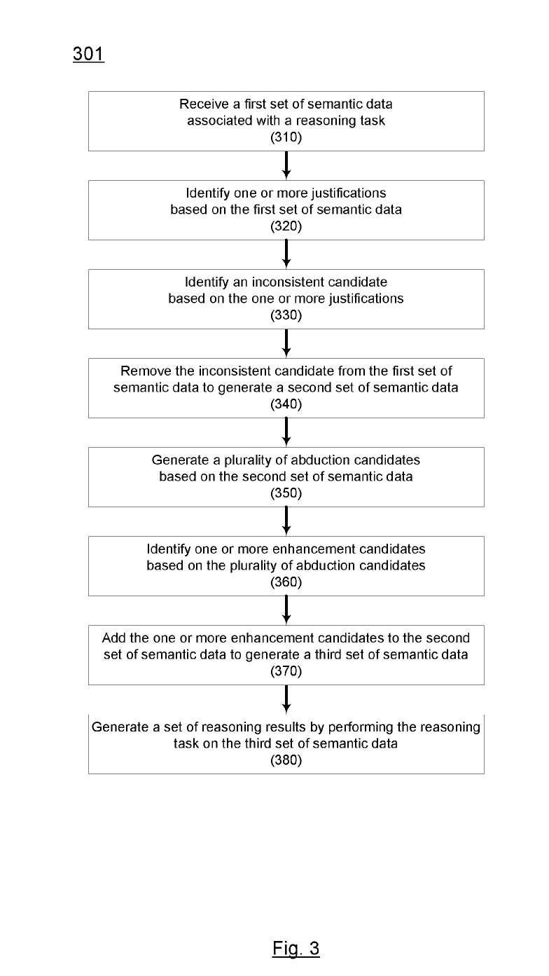

FIG. 3 is a flowchart of an illustrative method 301 for enhancing data to be used by a reasoning task, arranged in accordance with at least some embodiments described herein. Method 301 includes blocks 310, 320, 330, 340, 350, 360, 370, and 380. Although the blocks in FIG. 3 and other figures in the present disclosure are illustrated in a sequential order, these blocks may also be performed in parallel, and/or in a different order than those described herein. Also, the various blocks may be combined into fewer blocks, divided into additional blocks, supplemented with additional blocks, and/or eliminated based upon the particular implementation.

Processing for method 301 may begin at block 310, “Receive a first set of semantic data associated with a reasoning task.” Block 310 may be followed by block 320, “Identify one or more justifications based on the first set of semantic data.” Block 320 may be followed by block 330, “Identify an inconsistent candidate based on the one or more justifications.” Block 330 may be followed by block 340, “Remove the inconsistent candidate from the first set of semantic data to generate a second set of semantic data.” Block 340 may be followed by block 350, “Generate a plurality of abduction candidates based on the second set of semantic data.” Block 350 may be followed by block 360, “Identify one or more enhancement candidates based on the plurality of abduction candidates.” Block 360 may be followed by block 370, “Add the one or more enhancement candidates to the second set of semantic data to generate a third set of semantic data.” And block 370 may be followed by block 380, “Generate a set of reasoning results by performing the reasoning task based on the third set of semantic data.”

At block 310, a data enhancement module of a reasoning system may receive a first set of semantic data associated with a reasoning task. The first set of semantic data may contain coarse data, which may also be referred to as an inconsistent and/or incomplete ontology for the reasoning task.

At block 320, the data enhancement module may generate a second set of semantic data by removing inconsistent data from the first set of semantic data. The inconsistent data may be identified from the first set of semantic data by a justification determination process. Specifically, the data enhancement module may identify one or more justifications based on the first set of semantic data. Each of the one or more justifications may contain a plurality of elements selected from the first set of semantic data. The plurality of elements may be inconsistent in an ontology. However, removing one element from the plurality of elements may make the rest of the plurality of elements consistent in the ontology.

In some embodiments, the data enhancement module may divide the first set of semantic data into a first half of data and a second half of data. Upon a determination that the first half of data is inconsistent in the ontology, the data enhancement module may process the first half of data to generate the one or more justifications. Likewise, the data enhancement module may process the second half of data to generate the one or more justifications upon a determination that the second half of data is inconsistent in the ontology. Alternatively, upon a determination that the first half of data and the second half of data are inconsistent in the ontology, the data enhancement module may generate the one or more justifications based on the first half of data and the second half of data.

At block 330, the data enhancement module may identify an inconsistent candidate based on the one or more justifications identified at block 320. Specifically, the data enhancement module may first generate one or more relevance candidates by calculating a Cartesian product of the one or more justifications. For each relevance candidate in the one or more relevance candidates, the data enhancement module may calculate a corresponding semantic relatedness score based on the relevance candidate and the reasoning task. Afterward, the data enhancement module may select the inconsistent candidate from the one or more relevance candidates for having a corresponding semantic relatedness score that is below a predetermined threshold. Alternatively, the data enhancement module may select one of the relevance candidates that have the least semantic relatedness score as the inconsistent candidate.

In some embodiments, the data enhancement module may calculate a corresponding semantic relatedness score based on web statistics. The data enhancement module may select a first axiom from a specific relevance candidate and a second axiom from the reasoning task. Afterward, the data enhancement module may receive, from a search engine, a first hit score for the first axiom, a second hit score for the second axiom, and a third hit score for a combination of the first axiom and the second axiom. The data enhancement module may calculate the corresponding semantic relatedness score by using the first hit score, the second hit score, and the third hit score.

In some embodiments, the data enhancement module may calculate the corresponding semantic relatedness score based on web contents. The data enhancement module may select a first axiom from the specific relevance candidate and a second axiom from the reasoning task. Afterward, the data enhancement module may receive, from the search engine, a first plurality of contents related to the first axiom and a second plurality of contents related to the second axiom. The data enhancement module may calculate the corresponding semantic relatedness score by using the first plurality of contents and the second plurality of contents.

At block 340, the data enhancement module may remove the inconsistent candidate from the first set of semantic data to generate a second set of semantic data. Specifically, the data enhancement module may appoint one or more elements in the inconsistent candidate as the inconsistent data to be removed from the first set of semantic data. Thus, the second set of semantic data may be deemed a consistent data set.

At block 350, the data enhancement module may try to solve incomplete data in the second set of semantic data by first generating a plurality of abduction candidates based on an observation and the second set of semantic data. Specifically, the data enhancement module may construct a complete forest, and utilized a tableau algorithm to identify the plurality of abduction candidates.

At block 360, for each abduction candidate selected from the plurality of abduction candidates, the data enhancement module may calculate a corresponding semantic relatedness score based on the abduction candidate and the observation. The data enhancement module may then select one or more enhancement candidates from the plurality of abduction candidates for having corresponding semantic relatedness scores that are above a predetermined threshold.

At block 370, the data enhancement module may generate a third set of semantic data by adding enhancement data to the second set of semantic data. Specifically, the enhancement data, which is obtained by the above abduction determination process, may contain one or more enhancement candidates. The data enhancement module may add the one or more enhancement candidates as the enhancement data to the second set of semantic data, in order to generate the third set of semantic data. Thus, the third set of semantic data may contain a self-consistent and self-complete ontology for the reasoning task.

At block 380, the data enhancement module may generate a set of reasoning results by performing the reasoning task based on the third set of semantic data.

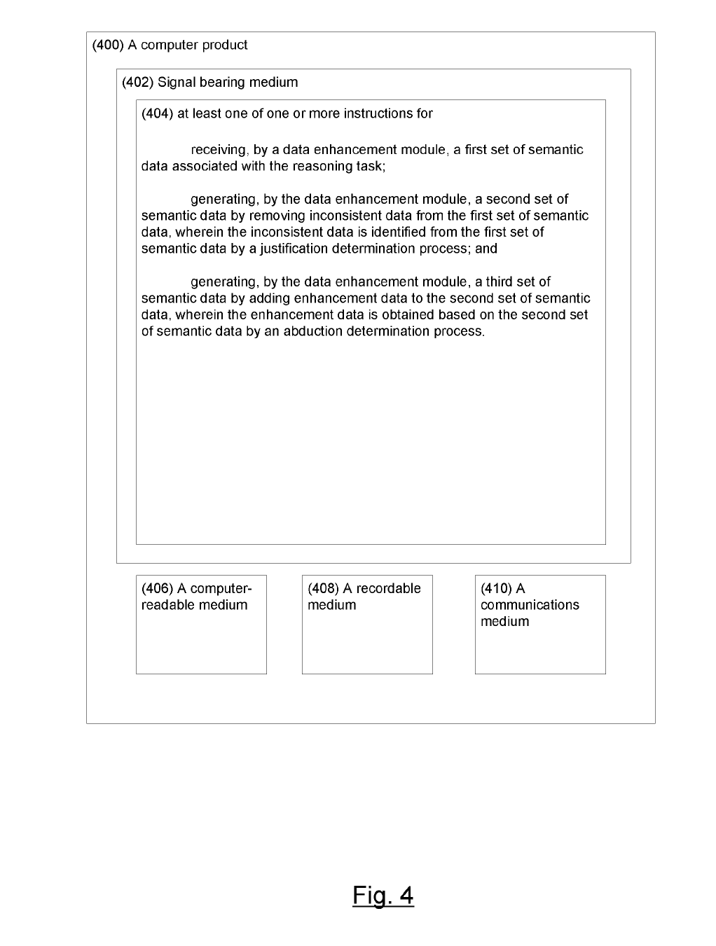

FIG. 4 is a block diagram of an illustrative computer program product 400 implementing a method for enhancing data to be used by a reasoning task, arranged in accordance with at least some embodiments described herein. Computer program product 400 may include a signal bearing medium 402. Signal bearing medium 402 may include one or more sets of non-transitory machine-executable instructions 404 that, when executed by, for example, a processor, may provide the functionality described above. Thus, for example, referring to FIG. 1, the reasoning system may undertake one or more of the operations shown in at least FIG. 3 in response to the instructions 404.

In some implementations, signal bearing medium 402 may encompass a non-transitory computer readable medium 406, such as, but not limited to, a hard disk drive, a Compact Disc (CD), a Digital Versatile Disk (DVD), a digital tape, memory, etc. In some implementations, signal bearing medium 402 may encompass a recordable medium 408, such as, but not limited to, memory, read/write (R/W) CDs, R/W DVDs, etc. In some implementations, signal bearing medium 402 may encompass a communications medium 410, such as, but not limited to, a digital and/or an analog communication medium (e.g., a fiber optic cable, a waveguide, a wired communications link, a wireless communication link, etc.). Thus, for example, referring to FIG. 1, computer program product 400 may be wirelessly conveyed to the reasoning system 120 by signal bearing medium 402, where signal bearing medium 402 is conveyed by communications medium 410 (e.g., a wireless communications medium conforming with the IEEE 802.11 standard). Computer program product 400 may be recorded on non-transitory computer readable medium 406 or another similar recordable medium 408.

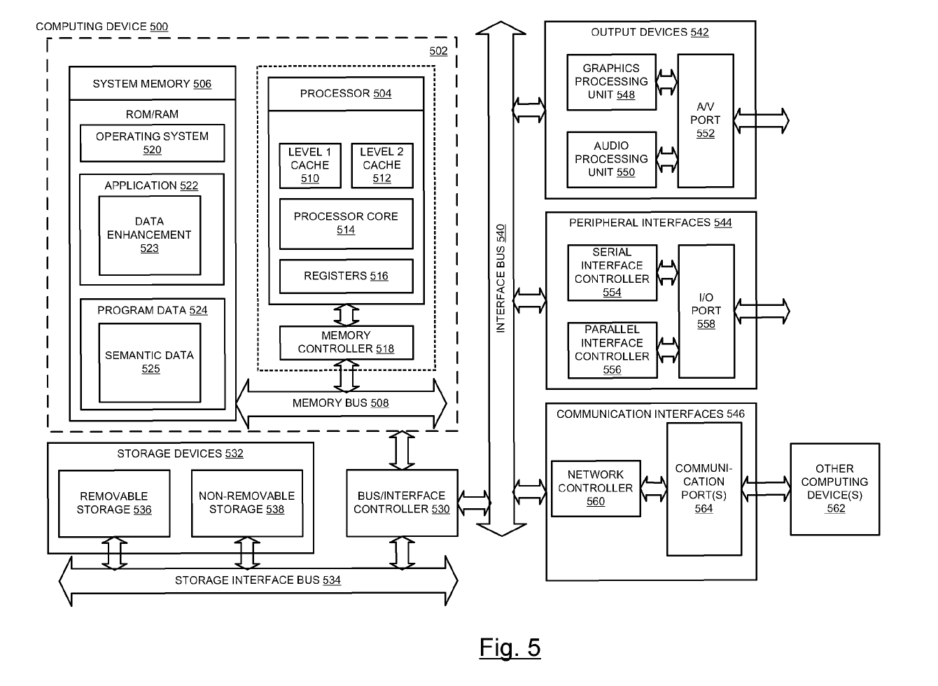

FIG. 5 is a block diagram of an illustrative computer device which may be used to enhance data to be used by a reasoning task, arranged in accordance with at least some embodiments described herein. In a basic configuration, computing device 500 typically includes one or more host processors 504 and a system memory 506. A memory bus 508 may be used for communicating between host processor 504 and system memory 506.

Depending on the particular configuration, host processor 504 may be of any type including but not limited to a microprocessor (μP), a microcontroller (μC), a digital signal processor (DSP), or any combination thereof. Host processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with host processor 504, or in some implementations memory controller 518 may be an internal part of host processor 504.

Depending on the particular configuration, system memory 506 may be of any type including but not limited to volatile memory (such as RAM), non-volatile memory (such as ROM, flash memory, etc.), or any combination thereof. System memory 506 may include an operating system 520, one or more applications 522, and program data 524. Application 522 may include a data enhancement function 523 that can be arranged to perform the functions as described herein, including those described with respect to at least the method 301 in FIG. 3. Program data 524 may include semantic data 525 utilized by the data enhancement function 523. In some embodiments, application 522 may be arranged to operate with program data 524 on operating system 520 such a method to enhance data to be used by a reasoning task, as described herein. This described basic configuration 502 is illustrated in FIG. 5 by those components within the inner dashed line.

Computing device 500 may have additional features or functionality, and additional interfaces to facilitate communications between basic configuration 502 and any required devices and interfaces. For example, a bus/interface controller 530 may be used to facilitate communications between basic configuration 502 and one or more data storage devices 532 via a storage interface bus 534. Data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 506, removable storage devices 536, and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

Computing device 500 may also include an interface bus 540 for facilitating communication from various interface devices (e.g., output devices 542, peripheral interfaces 544, and communication interfaces 546) to basic configuration 502 via bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication interface 546 includes a network controller 560, which may be arranged to facilitate communications with one or more other computing devices 562 over a network communication link via one or more communication ports 564. In some implementations, other computing devices 562 may include a multi-core processor, which may communicate with the host processor 504 through the interface bus 540.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the particular vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In some embodiments, several portions of the subject matter described herein may be implemented via Application Specific Integrated Circuits (ASICs), Field Programmable Gate Arrays (FPGAs), digital signal processors (DSPs), or other integrated formats.

Some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware is possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link and/or channel, a wireless communication link and/or channel, etc.).

The devices and/or processes are described in the manner set forth herein, and thereafter engineering practices may be used to integrate such described devices and/or processes into data processing systems. That is, at least a portion of the devices and/or processes described herein can be integrated into a data processing system via a reasonable amount of experimentation. A typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The subject matter described herein sometimes illustrates different components contained within, or connected with, different other components. Such depicted architectures are merely examples and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, the terms may be translated from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense generally understood for the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense generally understood for the convention (e.g., “a system having at least one of A, B, or C” would include but not be limited to systems that have A alone, B alone, C alone, A and B together, A and C together, B and C together, and/or A, B, and C together, etc.). Virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments are possible. The various aspects and embodiments disclosed herein are for purposes of illustration and are not intended to be limiting, with the true scope and spirit being indicated by the following claims.

We claim:

1. A method for enhancing data to be used by a reasoning task, the method comprising:
receiving, by a data enhancement module, a first set of semantic data associated with the reasoning task;
generating, by the data enhancement module, a second set of semantic data by removing inconsistent data from the first set of semantic data, wherein the inconsistent data is identified from the first set of semantic data by a justification determination process; and
generating, by the data enhancement module, a third set of semantic data by adding enhancement data to the second set of semantic data, wherein the enhancement data is obtained based on the second set of semantic data by an abduction determination process.

2. The method of claim 1, further comprising:
generating a set of reasoning results by performing the reasoning task based on the third set of semantic data.

3. The method of claim 1, wherein the first set of semantic data contains an inconsistent and incomplete ontology for the reasoning task, and the third set of semantic data contains a consistent and complete ontology for the reasoning task.

4. The method of claim 1, wherein the justification determination process comprises:
identifying one or more justifications based on the first set of semantic data, wherein each of the one or more justifications contains a plurality of elements selected from the first set of semantic data, the plurality of elements are inconsistent in an ontology, and removing one element from the plurality of elements makes the rest of the plurality of elements consistent in the ontology;
identifying an inconsistent candidate based on the one or more justifications; and
appointing one or more elements in the inconsistent candidate as the inconsistent data removed from the first set of semantic data.

5. The method of claim 4, wherein identifying the inconsistent candidate comprises:
generating one or more relevance candidates from the one or more justifications;
for each relevance candidate in the one or more relevance candidates, calculating a corresponding semantic relatedness score based on the relevance candidate and the reasoning task; and
selecting the inconsistent candidate from the one or more relevance candidates for having a corresponding semantic relatedness score that is below a predetermined threshold.

6. The method of claim 5, wherein calculating the corresponding semantic relatedness score comprises:
selecting a first axiom from the inconsistent candidate and a second axiom from the reasoning task;
receiving, from a search engine, a first hit score for the first axiom, a second hit score for the second axiom, and a third hit score for a combination of the first axiom and the second axiom; and
calculating the corresponding semantic relatedness score by using the first hit score, the second hit score, and the third hit score.

7. The method of claim 5, wherein calculating the corresponding semantic relatedness score comprises:
selecting a first axiom from the inconsistent candidate and a second axiom from the reasoning task;
receiving, from a search engine, a first plurality of contents related to the first axiom and a second plurality of contents related to the second axiom; and
calculating the corresponding semantic relatedness score by using the first plurality of contents and the second plurality of contents.

8. The method of claim 1, wherein the abduction determination process comprises:
generating a plurality of abduction candidates based on an observation and the second set of semantic data;
for each abduction candidate selected from the plurality of abduction candidates, calculating a corresponding semantic relatedness score based on the abduction candidate and the observation;
selecting one or more enhancement candidates from the plurality of abduction candidates for having corresponding semantic relatedness scores that are above a predetermined threshold; and
adding the one or more enhancement candidates as the enhancement data to the second set of semantic data.

9. A method for enhancing data to be used by a reasoning task, the method comprising:
receiving, by a data enhancement module, a first set of data associated with the reasoning task;
identifying, by the data enhancement module via a justification determination process, inconsistent data from the first set of data;
generating, by the data enhancement module, a second set of data by removing the inconsistent data from the first set of data;
generating, by the data enhancement module via an abduction determination process, enhancement data based on the second set of data; and
generating, by the data enhancement module, a third set of data by adding the enhancement data to the second set of data, wherein the third set of data contains a self-consistent and self-complete ontology for the reasoning task.

10. The method of claim 9, wherein identifying the inconsistent data comprises:
calculating a plurality of justifications based on the first set of data, wherein each of the plurality of justifications contains a corresponding plurality of elements selected from the first set of data, and the corresponding plurality of elements are inconsistent in an ontology;
generating a plurality of relevance candidates based on the plurality of justifications; and
identifying an inconsistent candidate from the plurality of relevance candidates as the inconsistent data.

11. The method of claim 10, wherein calculating the plurality of justifications comprises:
dividing the first set of data into a first half of data and a second half of data;
upon a determination that the first half of data is inconsistent in the ontology, generating one of the plurality of justifications based on the first half of data.

12. The method of claim 11, wherein calculating the plurality of justifications further comprises:
upon a determination that the first half of data and the second half of data are inconsistent in the ontology, generating one of the plurality of justifications based on the first half of data and the second half of data.

13. The method of claim 10, wherein generating the plurality of relevance candidates comprises:
utilizing a Cartesian product of the plurality of justifications as the plurality of relevance candidates.

14. The method of claim 10, wherein identifying the inconsistent candidate comprises:
selecting one of the plurality of relevance candidates that has the least relatedness with the reasoning task as the inconsistent candidate.

15. The method of claim 9, wherein generating the enhancement data from the second set of data comprises:
obtaining a plurality of abduction candidates related to an observation based on the second set of semantic data; and
selecting a plurality of enhancement candidates from the plurality of abduction candidates as the enhancement data for having corresponding semantic relatedness scores that are above a predetermined threshold.

16. A system for performing a reasoning task, the system comprising:
a data enhancement module configured to
receive a first set of semantic data,
generate a second set of semantic data by removing inconsistent data from a first set of semantic data, the inconsistent data being identified from the first set of semantic data by a justification determination process, and
generate a third set of semantic data by adding enhancement data to the second set of semantic data, the enhancement data being obtained based on the second set of semantic data by an abduction determination process; and
a reasoning engine coupled with the data enhancement module, the reasoning engine configured to generate a set of reasoning results based on the third set of semantic data.

17. The system as recited in claim 16, wherein the data enhancement module comprising:
an inconsistency reduction unit configured to identify the inconsistent data; and
a completeness enhancement unit configured to obtaining the enhancement data.

18. A non-transitory machine-readable medium having a set of instructions which, when executed by a processor, cause the processor to perform a method for enhancing data to be used by a reasoning task, the method comprising:
receiving, by a data enhancement module, a first set of semantic data associated with the reasoning task;
generating, by the data enhancement module, a second set of semantic data by removing inconsistent data from the first set of semantic data, wherein the inconsistent data is identified from the first set of semantic data by a justification determination process; and
generating, by the data enhancement module, a third set of semantic data by adding enhancement data to the second set of semantic data, wherein the enhancement data is obtained based on the second set of semantic data by an abduction determination process.

19. The non-transitory machine-readable medium of claim 18, wherein the justification determination process comprises:
identifying one or more justifications based on the first set of semantic data, wherein each of the one or more justifications contains a plurality of elements selected from the first set of semantic data, the plurality of elements are inconsistent in an ontology, and removing one element from the plurality of elements makes the rest of the plurality of elements consistent in the ontology; and
identifying an inconsistent candidate based on the one or more justifications; and
appointing one or more elements in the inconsistent candidate as the inconsistent data removed from the first set of semantic data.

20. The non-transitory machine-readable medium of claim 18, wherein the abduction determination process comprises:
generating a plurality of abductions candidates based on an observation and the second set of semantic data;
for each abduction candidate selected from the plurality of abduction candidates, calculating a corresponding semantic relatedness score based on the abduction candidate and the observation;
selecting one or more enhancement candidates from the plurality of abduction candidates for having corresponding semantic relatedness scores that are above a predetermined threshold; and
adding the one or more enhancement candidates as the enhancement data to the second set of semantic data.
